(19) United States
(12) Patent Application Publication
(10) Pub. No.: US 2020/0189204 A1
(43) Pub. Date: Jun. 18, 2020

(54) Laser Welding Using Intersecting Laser Beams

(71) Applicant: Branson Ultrasonics Corporation, Danbury, CT (US)

(72) Inventor: Scott CALDWELL, New Milford, CT (US)

(73) Assignee: Branson Ultrasonics Corporation, Danbury, CT (US)

(21) Appl. No.: 16/613,276

(22) PCT Filed: Apr. 25, 2018
(86) PCT No.: PCT/US2018/029286

§ 371 Date: Nov. 13, 2019

Related U.S. Application Data
(60) Provisional application No. 62/507,268, filed on May 17, 2017.

(51) Int. Cl. B29C 65/16; B23K 26/06; B23K 26/044; B23K 26/082; B23K 26/08; B23K 26/324; B29C 65/00

(52) U.S. Cl. CPC B29C 65/1667; B23K 26/0608; B23K 26/044; B29C 66/90; B23K 26/0869; B23K 26/324; B23K 26/082

(57) ABSTRACT

Plastic parts are welded with a true 3D volumetric weld using intersecting multi-beam trace laser welding in which a plurality of spot laser beams having the same wavelength are directed to the so that the laser beams intersect each other at a point along a weld path within one of the plastic parts at an angle in an intersection angle range between ten degrees and ninety degrees. The plurality of laser beams are traced so that the intersection of the plurality of laser beams traces along the weld path to form a weld pattern that is linear, curvilinear, planar or three dimensional along a joint that is inside a volume of plastic. The plastic part in which the laser beams intersect is partially absorptive to laser light at a wavelength and the laser beams have this wavelength.

### CROSS-REFERENCE TO RELATED APPLICATIONS

This application claims the benefit of U.S. Provisional Application No. 62/507,268 filed on May 17, 2017. The entire disclosure of the above application is incorporated herein by reference.

### FIELD

The present disclosure relates to laser welding.

### BACKGROUND

This section provides background information related to the present disclosure which is not necessarily prior art.

Trace laser welding and scanning laser welding are commonly used to weld clear plastic parts together. A spot laser tracks a weld path by movement of the laser device and/or laser beam, work piece, or a combination thereof. Trace laser welding systems use a movable frame to which the laser light source is mounted, such as a gantry, to move the laser beam and scan laser welding systems use a Galvo mirror to move the laser beam. However, the term “trace laser welding” in the context of laser welding systems is sometimes broadly used for both types of laser welding system and as used herein has this broader meaning.

FIG. 1 is a diagrammatic view of a trace laser welding system 10. Trace laser welding system 10 includes a laser support unit 12 including a controller 14, an interface 16, a laser power supply 18 and a chiller 20. Trace laser welding system 10 also includes a laser 22 coupled to laser support unit 12. Laser 22 includes a source of laser light 24, such as a laser diode. Laser light source 24 generates a laser beam 26 which is directed the parts 28, 30 being welded together. Laser beam 26 tracks along weld path 32 to weld parts 28, 30 together at weld path 32. It should be understood that the clear plastic parts are clear to the eye (e.g., clear in the visible spectrum) but at least one of the plastic parts is made of a material that is at least partially absorptive to laser light at the wavelength of the laser beam, such as two microns. In some cases, the clear plastic part (or parts) are highly absorptive to the laser beam. In this context, highly absorptive means that the plastic part or parts are made of a material that is least sixty percent absorptive at the wavelength of the laser beam. In these cases, the plastic part between the laser and joint is typically thin, having a thickness of ¼ inches or less.

Because the clear plastic part absorbs the two micron laser beam volumetrically, when radiating a spot along the weld path with a single laser beam if the intensity of the laser beam is high enough to melt the clear plastic part, the intensity is too high for the laser beam to penetrate through any substantial volume of material of the clear plastic part. Thus, the weld will be a surface weld. Further the clear plastic part through which the laser light travels therefore has to be fairly thin. Thus, true 3D welds inside a volume are not practically feasible with the aforementioned trace laser welding. It is thus an object of the present disclosure to provide laser welding that can weld clear plastic parts together with true 3D volumetric welds.

### SUMMARY

This section provides a general summary of the disclosure, and is not a comprehensive disclosure of its full scope or all of its features.

Plastic parts are welded in a laser welding system in accordance with one or of the below described aspects. At least one of the plastic parts is a partially absorptive plastic part that is partially absorptive to laser light at an absorption wavelength.

In an aspect, the plastic parts are welded in an intersecting multi-beam laser welding system having at least two trace laser welding subsystems. Each trace laser welding system includes a laser that generates a laser beam having the absorption wavelength. The trace laser welding subsystems are configured to direct their laser beams to the plastic parts so that they intersect each other at a point along a weld path within the partially absorptive plastic part at an angle in an intersection angle range between ten degrees and ninety degrees. Each trace laser welding subsystem is configured so that its laser generates its laser beam at an intensity that is lower than an intensity that will cause a material of which the partially absorptive plastic part is made to reach a melting temperature and an intensity high enough so that an intensity of laser energy at the intersection of laser beams is high enough to cause the material of which the partially absorptive plastic part is made to reach a melting temperature and melt.

In an aspect, the trace laser welding subsystems are configured to trace their respective laser beams so that the intersection of the laser beams traces around the weld path.

In an aspect, each trace laser welding subsystem includes a galvanometer mirror that traces the laser beam.

In an aspect, each trace laser welding subsystem includes a movable frame to which a laser light source that generates the laser beam is affixed that is moved to trace the laser beam.

In an aspect, one of the trace laser welding subsystems includes a galvanometer mirror that traces the laser beam and another one of the trace laser welding system includes a movable frame to which a laser light source that generates the laser beam is affixed that is moved to trace the laser beam.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a diagrammatic view of an example of a prior art trace laser welding system;

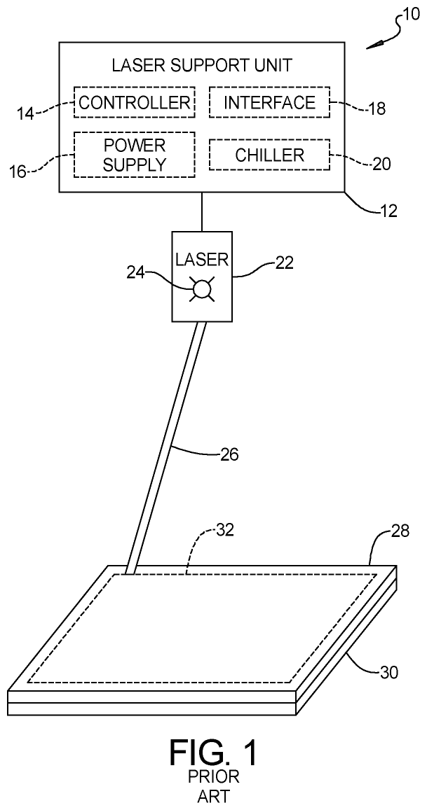

FIG. 2 is a diagrammatic view of a trace laser welding system in accordance with an aspect of the present disclosure;

FIG. 3 is a diagrammatic view of another trace laser welding system in accordance with an aspect of the present disclosure; and

FIG. 4 is a diagrammatic view of a laser welding system in accordance with an aspect of the present disclosure that is a hybrid of the laser welding systems of FIGS. 2 and 3.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

In accordance with an aspect of the present disclosure, plastic parts are welded with a true 3D volumetric weld using intersecting multi-beam trace laser welding in which a plurality of spot laser beams having the same wavelength are directed to the parts so that the laser beams intersect each other at a point along a weld path within one of the plastic parts at an angle in an intersection angle range between ten degrees and ninety degrees. The plurality of laser beams are traced so that the intersection of the plurality of laser beams traces along the weld path to form a weld pattern that is linear, curvilinear, planar or three dimensional along a joint that is inside a volume of plastic.

The plastic part in which the laser beams intersect is partially absorptive to laser light at a wavelength and the laser beams have this wavelength. This plastic part in which the laser beams intersect may be referred to herein as the partially absorptive plastic part. The wavelength at which the partially absorptive material of the partially absorptive plastic part is partially absorptive to laser light may sometimes be referred to herein as the absorption wavelength. It should be understood that the partially absorptive part is only partially absorptive to the laser light and not fully absorptive. Illustratively, the partially absorptive plastic part has an absorptivity in the range of fifteen percent to eighty percent. Illustratively, this absorption wavelength is two microns as polymers generally are partially absorptive to laser light at a wavelength around two microns. It should be understood that this absorption wavelength can be other than two microns and is dependent on the material of which the partially absorptive plastic part in which the laser beams intersect is made. It should be understood that the other part can also be partially absorptive to laser light at the absorption wavelength, but also can be transmissive or opaque to laser light at the absorption wavelength. It should be understood that the plastic parts may be clear to the eye, tinted, opaque the eye, but at least one of the parts is partially absorptive to laser light at the absorption wavelength.

The intensity of each laser beam is below an intensity that causes the polymer of the partially absorptive plastic part to melt. At the point where the laser beams intersect, the intensity is at or above the intensity that causes the polymer of the partially absorptive plastic part to melt. The laser beams intersect at an angle in an intersection angle range between ten degrees and ninety degrees. This angle at which they intersect each other is for example determined heuristically to melt a desired portion of the partially absorptive clear plastic part where the laser beams intersect. It should be understood that more than two intersecting laser beams can be used and the angle between any two intersecting laser beams determined as described above. In an aspect, the parts are clear plastic parts meaning that they are clear to the eye (that is, clear in the visible spectrum).

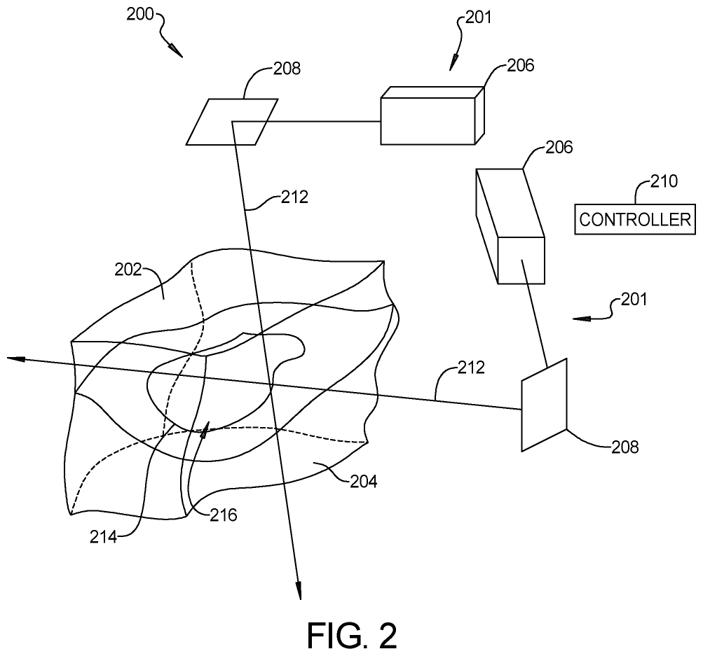

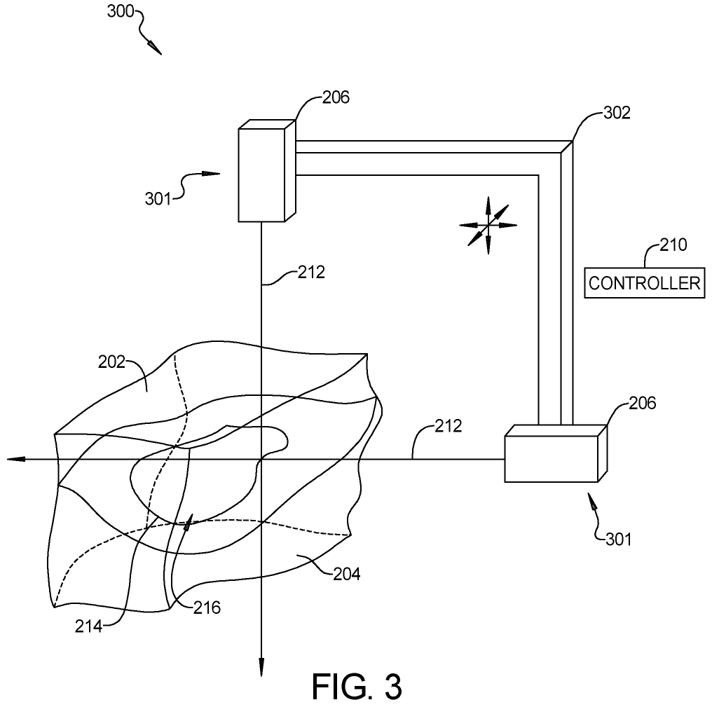

FIG. 3 is a simplified diagrammatic view of an intersecting multi-beam trace laser welding system 200 in accordance with an aspect of the present disclosure for welding clear plastic parts 202, 204. Intersecting multi-beam trace laser welding system 200 includes a plurality of trace laser welding subsystems 201, illustratively two in the example shown in FIG. 2. Each trace laser welding subsystem 201 includes a laser 206 and a galvanometer mirror 208 associated with that laser 206. Intersecting multi-beam trace laser welding system 200 includes a controller 210 configured to control lasers 206 and Galvo mirrors 208. In laser welding, a galvanometer mirror is commonly known as a Galvo mirror and is a device that move a laser beam by rotating a mirror with a galvanometer setup. Laser beams 212 generated by lasers 206 intersect each other at a point along a weld path 214 in partially absorptive plastic part 202 which is partially absorptive to laser light at the wavelength of laser beams 212 and are moved so that the intersection of the laser beams 212 traces along the weld path 214 to form a true 3D volumetric weld 216. In this regard, laser beams 212 intersect each other at a point along the weld path as they are traced along the weld path 214. Laser beams 212 each have the absorption wavelength at which partially absorptive plastic part 202 is absorptive to laser light, such as two microns. Each laser 206 is controlled by controller 210 to generate its laser beam 212 at an intensity that is less than an intensity need to cause the material of which partially absorptive plastic part 202 is made to reach a melting temperature. The intensity of laser energy where laser beams 212 intersect at a point along weld path 214 is at or above an intensity to cause the material of which partially absorptive plastic part 202 is made to reach a melting temperature and melt.

FIG. 3 is a simplified diagrammatic view of an intersecting multi-beam trace laser welding system 300 in accordance with an aspect of the present disclosure that is a variation of intersecting multi-beam trace welding system 200 and only the differences will be discussed. In intersecting multi-beam trace laser welding system 300, trace laser welding subsystems 301 have lasers 206 affixed to movable frame 302 that is movable with respect to parts 202, 204 being welded. Controller 210 is configured to control the movement of frame 302 with respect to parts 202, 204 to move laser beams 212 so that their intersection traces along weld path 214.

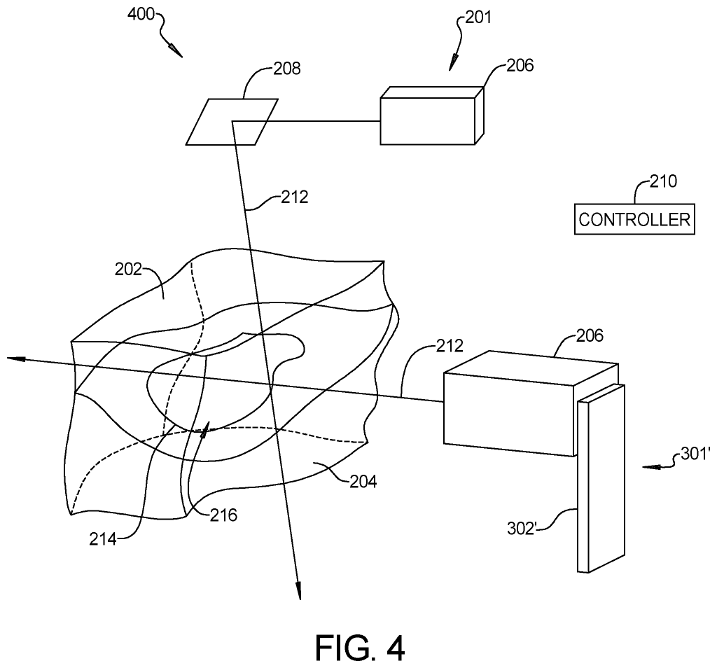

FIG. 4 is a simplified diagrammatic view of an intersecting multi-beam trace laser welding system 400 in accordance with an aspect of the present disclosure that is a variation of intersecting multi-beam trace welding system 200 and 300 and only the differences will be discussed. Multi-beam trace laser welding system 400 is a hybrid of intersecting multi-beam laser welding systems 200 (FIG. 2) and 300 (FIG. 3). Multi-beam trace laser welding system 400 includes trace laser welding subsystem 201 having laser 206 and a galvanometer mirror 208 associated with that laser 206. It also includes trace laser welding system 301′ with laser 206 affixed to movable frame 302.′ Controller 210 is configured to control Galvo mirror 208 to move the laser beam 212 generated by the laser 206 with which Galvo mirror 208 is associated and to control the movement of movable frame 302′ with respect to parts 202, 204 to move laser beams 212 so that their intersection traces along weld path 214.

It should be understood that partially absorptive plastic part 202 can be made of material that is partially absorptive to laser light at an absorption wavelength other than two microns. In which case, laser beams 212 will have this absorption wavelength.

Controller 210 can be or includes any of a digital processor (DSP), microprocessor, microcontroller, or other programmable device which are programmed with software implementing the above described logic. It should be understood that alternatively it is or includes other logic devices, such as a Field Programmable Gate Array (FPGA), a complex programmable logic device (CPLD), or application specific integrated circuit (ASIC). When it is stated that controller 210 performs a function or is configured to perform a function, it should be understood that controller 210 is configured to do so with appropriate logic (such as in software, logic devices, or a combination thereof). When it is stated that controller 210 has logic for a function, it should be understood that such logic can include hardware, software, or a combination thereof.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method of laser welding a plurality of plastic parts together wherein at least one of the plastic parts is partially absorptive to laser light at an absorption wavelength, comprising:
holding the plastic parts together;
generating a plurality of laser beams;
directing the plurality of laser beams to the plastic parts so that these laser beams intersect each other at an angle in an intersection angle range between ten degrees and ninety degrees at a point along a weld path within the partially absorptive part; and
wherein generating the plurality of laser beams includes generating each laser beam to have a wavelength that is the absorption wavelength and an intensity that is lower than an intensity that will cause a material of which the partially absorptive plastic part is made to reach a melting temperature and an intensity high enough so that an intensity of laser energy at the intersection of laser beams is high enough to cause the material of which the partially absorptive plastic part is made to reach a melting temperature and melt.

2. The method of claim 1 including tracing the plurality of laser beams so that the intersection of the plurality of laser beams traces around the weld path.

3. The method of claim 2 wherein tracing each laser beam includes tracing it with a galvanometer mirror.

4. The method of claim 2 wherein tracing the laser beams includes moving a movable frame to which lasers that generate the laser beams are affixed to trace the laser beams.

5. The method of claim 2 wherein tracing laser beams includes tracing one of the laser beams with a galvanometer mirror and tracing another of the laser beams includes moving a movable frame to which the laser generating that laser beam is affixed to trace that laser beam.

6. An intersecting multi-beam laser welding system for welding together a plurality of plastic parts received in the laser welding system wherein at least one of the plastic parts is partially absorptive to laser light at an absorption wavelength, comprising:
at two least trace laser welding subsystems each having a laser that generates a laser beam having the absorption wavelength;
the trace laser welding subsystems configured to direct their laser beams to the plastic parts so that they intersect each other at a point along a weld path within the partially absorptive plastic part at an angle in an intersection angle range between ten degrees and ninety degrees; and
each trace laser welding subsystem configured so that its laser generates its laser beam at an intensity that is lower than an intensity that will cause a material of which the partially absorptive plastic part is made to reach a melting temperature and an intensity high enough so that an intensity of laser energy at the intersection of laser beams is high enough to cause the material of which the partially absorptive plastic part is made to reach a melting temperature and melt.

7. The laser welding system of claim 6 wherein the trace laser welding subsystems are configured to trace their respective laser beams so that the intersection of the laser beams traces around the weld path.

8. The laser welding system of claim 7 wherein each trace laser welding subsystem includes a galvanometer mirror that traces the laser beam.

9. The laser welding system of claim 7 wherein each trace laser welding subsystem includes a movable frame to which a laser that generates the laser beam is affixed that is moved to trace the laser beam.

10. The laser welding system of claim 7 wherein one of the trace laser welding subsystems includes a galvanometer mirror that traces the laser beam and another one of the trace laser welding system includes a movable frame to which a laser light source that generates the laser beam is affixed that is moved to trace the laser beam.
